(19) United States
(12) Patent Application Publication
(10) Pub. No.: US 2012/0018671 A1
(43) Pub. Date: Jan. 26, 2012

(54) METHOD AND SYSTEM FOR ENHANCING SALT WATER EXHAUST SCRUBBER EFFICIENCY

(75) Inventor: James R. PLANT, Victoria (CA)

(73) Assignee: Q5 INNOVATIONS INC., Victoria (CA)

(21) Appl. No.: 13/185,999

(22) Filed: Jul. 19, 2011

Related U.S. Application Data
(60) Provisional application No. 61/366,343, filed on Jul. 21, 2010.

(51) Int. Cl. C09K 3/32

(52) U.S. Cl. 252/184

(57) ABSTRACT

A method for enhancing salt water exhaust scrubber efficiency in a scrubber unit using salt water as a scrubbing medium. The method involves monitoring salinity of salt water passing into the scrubber unit and mixing concentrated brine solution derived from a desalination unit with the salt water to maintain the salinity of the salt water passing into the scrubber unit.

### FIELD

There is described a method of enhancing salt water exhaust scrubbing efficiency, and maintaining scrubber operational efficiency in environments of low salinity.

### BACKGROUND

A vast amount of international trade is carried by ships, resulting in significant negative environmental impacts of increased levels of sulphur dioxide and particulate emissions from their exhaust. It has been estimated that 11.7% of all sulpher dioxide deposition in Southeast Asia (1), and approximately 6% in SE England (2) is attributable to shipping. In addition, in some sensitive ecosystems and close to ports, up to 55% of the critical loads of sulphur deposition originates from ship exhaust (2). Canals, harbours and inland waterways, having a high concentration of shipping in a limited and unchanging geographic route, have the potential to concentrate sulphur dioxide and particulate emissions in close proximity to densely populated areas.

Strict new guidelines have been adopted in North America and Europe regarding such ship exhaust emissions, with mandatory compliance required by 2015 in N.A. (3) and 2010 in Europe (4). The technical challenges to meeting such limits and deadlines have been significant, and apart from moving to the production and utilization of expensive low-sulphur fuel, there exists few efficient, demonstrable and readily available technical solutions (for example, U.S. Pat. Nos. 6,402,816 and 7,056,367, and United States Patent Application 20040255779). One operational solution, that is presently undergoing prototype testing, is the Krystallon™ sea water exhaust scrubbing system produced by Hamworthy (x). This sea water exhaust scrubbing technology has also been successfully adapted for treating the significant environmental impact caused by the emission of acidic exhaust from coastal and land based electrical generation plants.

In a marine application, the Krystallon™ exhaust scrubber works by exposing the ships exhaust stream to a flow of sea water, collecting this exhaust wash water, and processing the wash water to extract the captured exhaust particulates before discharging the wash water overboard. When the acidic sulphur dioxide containing exhaust interacts with the more basic calcium carbonate containing sea water, the pH of the exhaust is neutralized at the same time that the particulates are captured in the wash water. After filtering the wash water to remove suspended particulate matter, the wash water is mixed with fresh sea water (called reaction water) in an attempt to reduce its acidity before discharging the wash water over board. This is done to lessen any potential negative effects that discharging acidified water might have in the marine environment in immediate proximity to the ship.

Of particular and urgent concern is the fact that many canals, navigable channels and commercial ports are located in marine environments subject to significant freshwater inflow. Within such diluted salt water environments, current seawater exhaust scrubbing systems are outside of their operational specifications and fail to function effectively, or within mandated limits. The present invention discloses a method and procedure for re-establishing seawater exhaust scrubber operational efficiency in marine and coastal environments which are subject to significant freshwater inflow.

### SUMMARY

There is provided a method and system for utilizing the hypertonic brine solution (e.g. generated as a by-product of desalination processing) to supplement the ionic and carbonate concentrations of seawater utilized in seawater exhaust scrubbing treatments systems, or as exhaust scrubber feed water for land-based scrubber operations.

The concentrated and alkaline nature of the desalination by-product solution would allow for seawater exhaust scrubbing systems to continue operation in marine environments that have been diluted by freshwater inflow to a level of salinity and pH below that required for normal effective scrubber operation.

The proposed method can readily be implements in all sea going vessels that have desalination units. The source of the concentrated brine solution required to follow the teachings of the method can be a concentrated and hypertonic brine solution produced as a byproduct of the operation of a fresh water desalination unit. It will be appreciated that the concentrated brine solution can also be produced by a dedicated desalination unit.

The proposed enhanced sea water exhaust scrubbing method may be applied to land-based (coastal) scrubbing operations, such as in coal-fired electrical generation plants, and may be configured as a closed-loop system (in non-coastal regions) whereby the scrubbing water is filtered, adjusted to obtain the operational level of alkalinity, and re-used as scrubber feed water. In addition, ground water in many non-coastal regions often has very high concentrations of calcium carbonate, is alkaline, and as such this “Hard Water” could be utilized either directly or in a concentrated form as a substitute to sea water. Recently, waste heat from a fossil fuel electrical generation plant has been utilized to drive the distillation of up to 1.03 million gallons/day of fresh water through a process known as Diffusion Driven Desalination (ref). As a result, a vast amount of brine is produced on site, a potential and ready source of feed water for exhaust scrubbing operations.

### BRIEF DESCRIPTION OF THE DRAWINGS

These and other features will become more apparent from the following description in which reference is made to the appended drawings, the drawings are of marine applications for the purpose of illustration only and are not intended to be in any way limiting, wherein:

FIG. 1 is a a schematic illustration of a method and system for utilizing the hypertonic brine solution (generated as a by-product of desalination processing) to supplement the ionic and carbonate concentrations of seawater utilized in seawater exhaust scrubbing treatments systems.

FIG. 2 is a schematic illustration of the prior art showing a representation of the Krystallon™ seawater exhaust scrubbing system, and highlighting the fact that, at present, there exists no integration of ship-board desalination and exhaust scrubbing systems.

### DETAILED DESCRIPTION

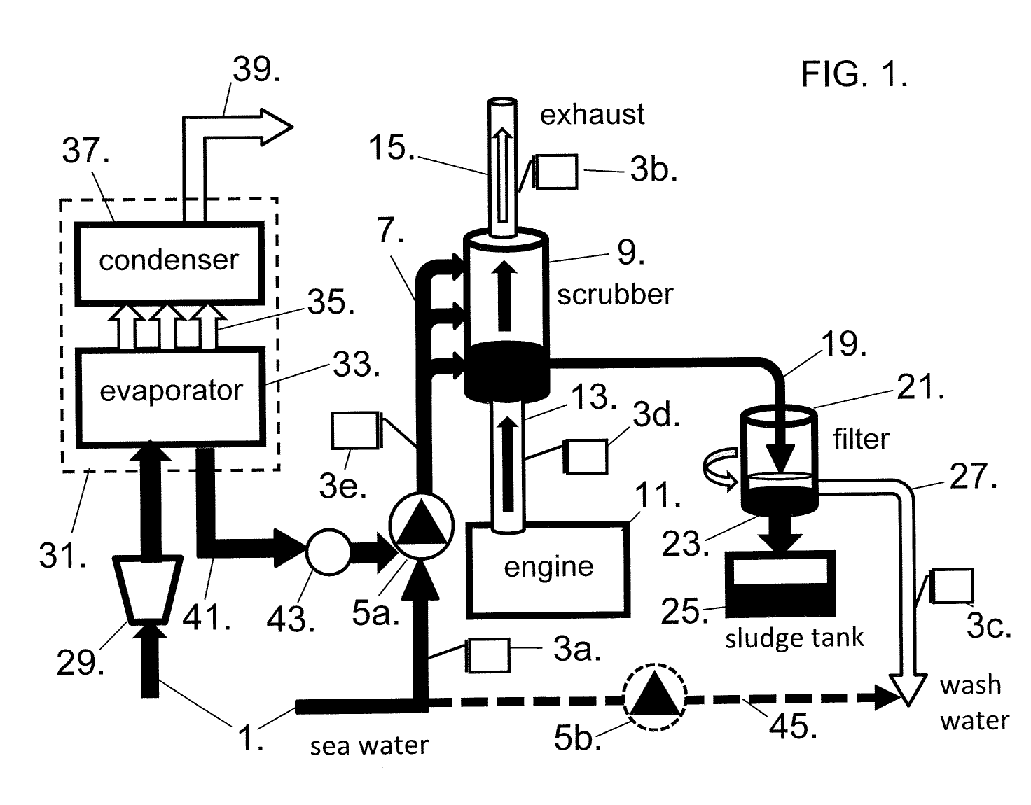

A Method and System for Enhancing Salt Water Exhaust Scrubber Efficiency, will now be described with reference to FIGS. 1. and 2.

FIG. 1. illustrates how the hypertonic brine solution produced as a byproduct of the operation of a desalination unit (contained within the dashed box, item 31), can be used to supplement the ionic and carbonate concentrations of sea water utilized in sea water exhaust scrubbing treatments systems, to allow the exhaust scrubbing system to operate in marine environments where salination, pH or ionic concentrations have been diluted by freshwater to levels outside of the system's operational parameters. The inflow of sea water (item 1.) passes through a filtration unit (item 29.) to create a supply of feed water for an evaporation desalination unit (item 31.). The feed water enters the evaporator (item 33.) where it is heated to produce water vapour (item 35.), and this water vapour enters into a condenser unit (item 37.) where it is condensed and collected to create desalinated water outflow (item 39.). The remaining brine solution (item 41.) then passes through a flow control unit (item 43.), to be directed into the intake side of the wash water feed pump (item 5a.).

Monitoring of scrubber operational efficiency is carried out through system sensors (sensor items 3a., 3b., 3c., 3d., 3e.) located at the raw sea water inflow (sensor item 3a.), at the scrubber feed water inflow (sensor item 3e.), the scrubber exhaust outflow (sensor item 3b.), the wash water discharge outflow (sensor item 3c.), and the untreated engine exhaust (item 13.) outflow (sensor item 3d.). Under conditions where the pH and salinity of the raw sea water (item 1.) drops below the exhaust scrubber's operational parameters (as detected by sensor 3a.), the brine flow control unit (item 43.) increases the proportion of the brine solution (item 41.) entering the wash water supply pump (item 5a.). The pH and salinity of the resultant wash water (item 7.) is monitored (by sensor item 3e.), as well as the effectiveness of the scrubber water to decrease the acidity of the engine exhaust (item 15.) gasses (monitored by sensor 3b.). Preliminary monitoring (by sensor item 3d.) of the exhaust inflow to the scrubber (item 13.) from the engine (item 11.), in comparison to the scrubber (item 9.) exhaust outflow (item 15.) would be required to establish a baseline for the exhaust scrubber systems efficiency.

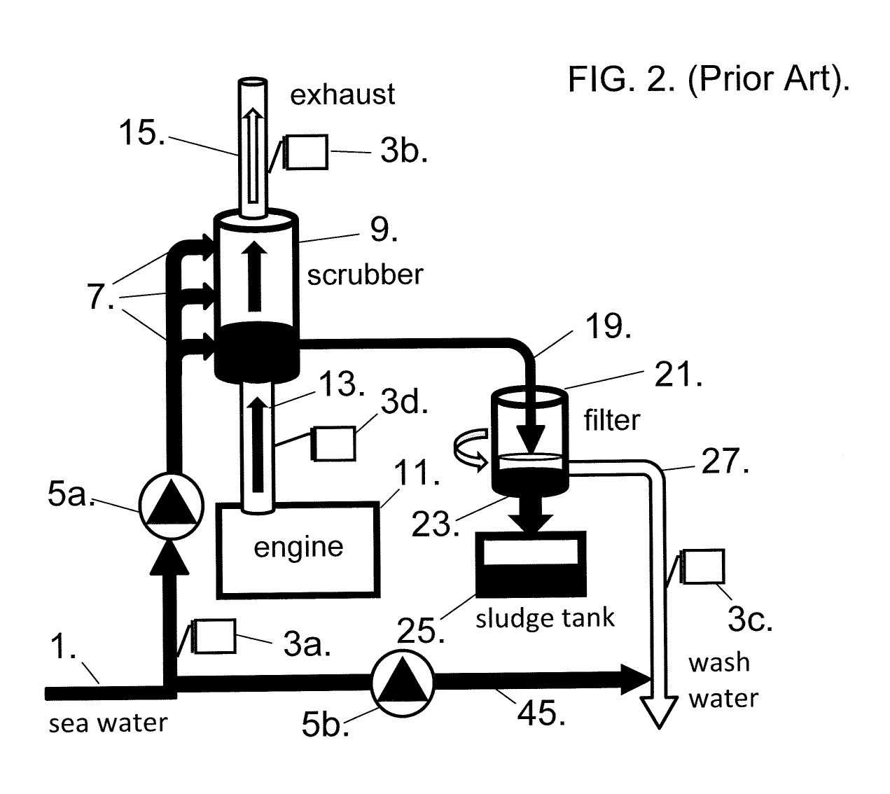

Dirty exhaust scrubber wash water (item 19.) is collected and filtered (item 21.), with the separated particulate matter being captured and stored in a sludge tank (item 25.). The cleaned wash water (item 27.) is subject to monitoring (by sensor item 3c.) prior to discharge. While the concentrated brine solution would contain higher than normal sea water levels of calcium carbonates (and would be significantly more alkaline than raw sea water), in the event that the scrubber discharge water is still too acidic, a flow of sea water (item 45.) can be pumped (utilizing pump item 5b.) to be mixed as a “reaction water” to reduce the acidity the wash water discharge as outlined in the prior art (see FIG. 2.).

FIG. 2. (Prior Art) is a schematic illustration of the existing Krystallon™ sea water exhaust scrubbing system produced by Hamworthy. Raw sea water (item 1.) is taken up and is monitored (by sensor item 3a.) to ensure adequate alkalinity for the exhaust scrubber function. Scrubbing water is pumped (by pump item 5a.) to multiple inlets (collectively labeled item 7.) on the exhaust scrubber (item 9.), which receives exhaust (item 13.) directly from the engine (item 11.). After scrubbing, the exhaust (item 15.) exiting the scrubber contains significantly less particulate matter and reduced acidity than the exhaust (item 13.) directly from the engine (item 11.) as documented by exhaust gas sensors (items 3b. and 3d.).

Dirty scrubber water (item 19.) passes through a filtration system (item 21.) which separates out the particulate matter (item 23.) which is subsequently transferred to a sludge holding tank (item 25.). The filtered scrubber wash water (item 27.) is monitored for acidity (utilizing sensor(s) 3c.), and near neutral pH is achieved through mixing approximately equal proportions of filtered scrubber water (item 27.) with “Reaction Water” (item 45.) which is pumped (utilizing pump item 5b.) from the raw sea water intake (item 1.).

### Variations

It should be clear that any form or process of desalination, (whether that be by evaporation, reverse osmosis or diffusion driven desalination), which results in the by-production of concentrated and alkaline brine solutions, can be adapted to enhance existing sea water exhaust scrubbing technologies. In addition, the feed water for such desalination processes need not be sea water, but can be sources such as “hard” ground water (having high concentrations of dissolved calcium carbonates) or oil field brine solutions.

### Cautionary Warnings

Careful consideration should be paid to (a) the design and on-going maintenance of any system which is exposed to concentrated brine solutions, due to its corrosive nature, and (b) the different density and hydrodynamic properties of concentrated brine solutions (as it relates to pumping and storage).

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method for enhancing salt water exhaust scrubber efficiency in a scrubber unit using salt water as a scrubbing medium, the method comprising:
monitoring salinity of the salt water passing into the scrubber unit;
mixing concentrated brine solution from a desalination unit with the salt water to maintain the salinity of the salt water passing into the scrubber unit.
